(19) United States
(12) Patent Application Publication
(10) Pub. No.: US 2008/0231210 A1
(43) Pub. Date: Sep. 25, 2008

(54) REMOTE-CONTROLLED DECORATION

(75) Inventor: Donna Baker Schwenk, Rockport, MA (US)

Correspondence Address: PAI PATENT & TRADEMARK LAW FIRM, 1001 FOURTH AVENUE, SUITE 3200, SEATTLE, WA, 98154, US

(73) Assignees: ONE PLUS TWO ASSOCIATED., LTD., Taipei (TW); DBS INTERNATIONAL LLC, Rockport, MA (US)

(21) Appl. No.: 11/689,510

(22) Filed: Mar. 22, 2007

(51) Int. Cl. H05B 37/02

(52) U.S. Cl. 315/292

(57) ABSTRACT

A remote-controlled decoration includes a decorative main body and a remote controller. The decorative main body includes an internal chamber, and a base mounted to a lower open end of the chamber. The base is provided with a circuit board connected to a power source, at least one LED light, and a receiver. The remote controller includes a signal transmitter for remotely transmitting a control signal to the receiver on the decorative main body, so as to control the LED light to light or extinguish.

### FIELD OF THE INVENTION

The present invention relates to a decoration, and more particularly, to a decoration that can be remotely controlled to heat, to change colors, to light, or to extinguish.

### BACKGROUND OF THE INVENTION

Decorations such as lighting fixtures and decorative fountains are frequently and widely used in home, bars, lounges, business offices, parties, banquets, dancing halls, café shops, gardens, yards, bathrooms, and many other suitable places. These decorations usually include a power switch for controlling a lighting circuit thereof, so as to turn on or turn off a light-emitting-diode (LED) light provided on the decorations. However, these conventional decorations with LED light are not remotely controllable and therefore inconvenient and impractical for use.

### SUMMARY OF THE INVENTION

A primary object of the present invention is to provide a remote-controlled decoration, which may be remotely controlled with a corresponding remote controller to light or extinguish.

To achieve the above object, the remote-controlled decoration according to the present invention includes a decorative main body and a remote controller. The decorative main body includes an internal chamber, and a base mounted to a lower open end of the chamber. The base is provided with a circuit board connected to a power source, at least one LED light, and a receiver. The remote controller includes a signal transmitter for remotely transmitting a control signal to the receiver on the decorative main body, so as to control the at least one LED light to light or extinguish.

Another object of the present invention is to provide the above-described remote-controlled decoration that has one or more LED light sources separately located at different heights.

To achieve the above object, the remote-controlled decoration according to the present invention includes multiple LED lights located at predetermined positions of different heights on the decorative main body, and connected to the circuit board on the base at the lower open end of the decorative main body, so that all the LED lights may be remotely controlled with the remote controller to light or extinguish.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a remote-controlled decoration according to an embodiment of the present invention; and

FIG. 2 is an exploded perspective view of the remote-controlled decoration of FIG. 1.

### DETAILED DESCRIPTION OF THE PREFERRED EMBODIMENTS

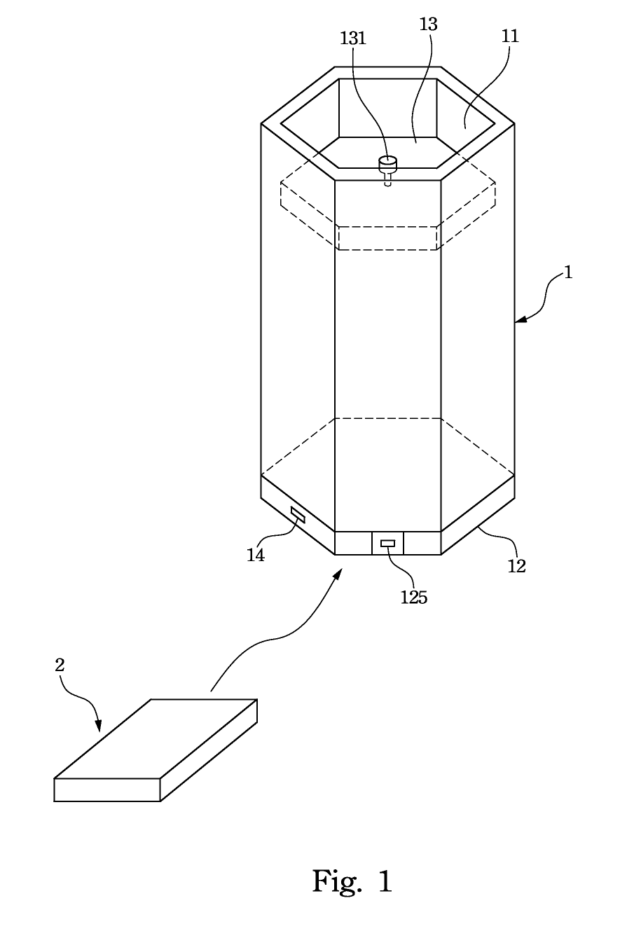

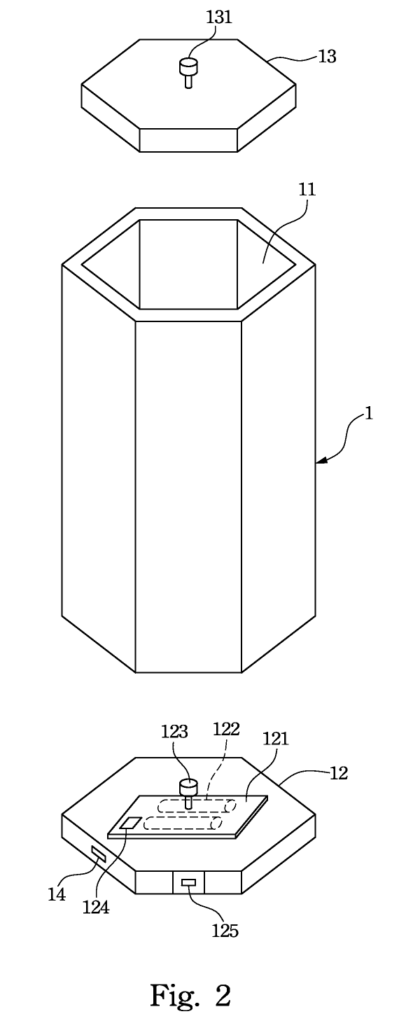

Please refer to FIGS. 1 and 2 that are assembled and exploded perspective views, respectively, of a remote-controlled decoration according to an embodiment of the present invention. As shown, the remote-controlled decoration of the present invention includes a decorative main body 1 and a remote controller 2.

The decorative main body 1 is internally provided with a chamber 11, to a lower open end of which a base 12 is mounted. The base 12 is provided at a predetermined position with a circuit board 121 connected to a power source 122, a first light-emitting-diode (LED) light 123, and a receiver 124.

The power source 122 for the decorative main body 1 may be a commercial power supply, batteries, or solar energy. The base 12 is provided at a predetermined position with a power switch 125 for controlling the on/off of the power source 122.

The remote controller 2 includes a signal transmitter (not shown) for transmitting an ON or OFF control signal to the receiver 124 on the base 12 of the decorative main body 1. When the receiver 124 receives the control signal, circuits on the circuit board 121 are actuated to control the first LED light 123 to light or extinguish. That is, the first LED light 123 on the decorative main body can be remotely controlled to light or extinguish, or to turn on or off.

The decorative main body 1 may further include a second LED light 131 located on, for example, a cap 13 mounted to an upper open end of the chamber 11. The second LED light 131 is electrically connected to the circuit board 121, and can therefore be controlled with the remote controller 2 to light or extinguish. With these arrangements, the decorative main body 1 may be lighted at positions of different heights to show a special lighting effect.

The decorative main body 1 is also provided with a fragrance diffuser 14, from which fragrance is spread out. The fragrance diffuser 14 may have adjustable fragrance levels and/or a remote-controlled on/off switch. The fragrance diffuser 14 may be a melter for wax, paraffin and natural products-liquid potpourri, oils, fragrance solids, paxcillated beads, and wickless tarts.

In practical applications, the decorative main body 1 may be a lighting fixture, such as, for example, a garden light, sidewalk and/or driveway lighting, borders and fencing, patio, tree/plant and shrub lighting, pool lighting accessories, a floating light unit, an oil lamp for lighting, a torch, a lantern unit, a sign, a wax candle with real flame, an electronic candle, a candle holder, or a work of art with light. Further, the decorative main body 1 may also be a decorative fountain, a waterglobe, a stepping stone, or seasonal indoor/outdoor decorations.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A remote-controlled decoration, comprising:
a decorative main body having an internal chamber, to a lower open end of which a base is mounted; the base being provided at a predetermined position with a circuit board connected to a power source, at least one LED Light, and a receiver; and
a remote controller having a signal transmitter for remotely transmitting a control signal to the receiver on the decorative main body, so as to control the at least one LED Light to light or extinguish.

2. The remote-controlled decoration as claimed in claim 1, wherein the decorative main body has at least two LED lights provided at predetermined positions of different heights in the chamber of the decorative main body, and being electrically connected to the circuit board to be remotely controllable with the remote controller.

3. The remote-controlled decoration as claimed in claim 1, wherein the power source is a commercial power supply.

4. The remote-controlled decoration as claimed in claim 1, wherein the power source includes one or more batteries.

5. The remote-controlled decoration as claimed in claim 1, wherein the power source is solar energy.

6. The remote-controlled decoration as claimed in claim 1, wherein the base is provided with a power switch for controlling on/off of the power source.

7. The remote-controlled decoration as claimed in claim 1, wherein the decorative main body is provided with a fragrance diffuser.

8. The remote-controlled decoration as claimed in claim 7, wherein the fragrance diffuser has adjustable fragrance levels and/or a remote-controlled on/off switch.

9. The remote-controlled decoration as claimed in claim 7, wherein the fragrance diffuser is a melter for wax, paraffin and natural products-liquid potpourri, oils, fragrance solids, paxcillated beads, and wickless tarts.

10. The remote-controlled decoration as claimed in claim 1, wherein the decorative main body is a lighting fixture.

11. The remote-controlled decoration as claimed in claim 10, wherein the lighting fixture is selected from the group consisting of a garden light, a sidewalk lighting, a driveway lighting, borders and fencing lighting, patio lighting, and tree, plant, and shrub lighting.

12. The remote-controlled decoration as claimed in claim 10, wherein the lighting fixture includes pool lighting accessories.

13. The remote-controlled decoration as claimed in claim 10, wherein the lighting fixture is a floating light unit.

14. The remote-controlled decoration as claimed in claim 10, wherein the lighting fixture is an oil lamp for lighting.

15. The remote-controlled decoration as claimed in claim 10, wherein the lighting fixture is a torch.

16. The remote-controlled decoration as claimed in claim 10, wherein the lighting fixture is a lantern unit.

17. The remote-controlled decoration as claimed in claim 10, wherein the lighting fixture is a sign.

18. The remote-controlled decoration as claimed in claim 10, wherein the lighting fixture is a wax candle with real flame.

19. The remote-controlled decoration as claimed in claim 10, wherein the lighting fixture is an electronic candle.

20. The remote-controlled decoration as claimed in claim 10, wherein the lighting fixture is candle holder.

21. The remote-controlled decoration as claimed in claim 10, wherein the lighting fixture is a work of art with light.

22. The remote-controlled decoration as claimed in claim 1, wherein the decorative main body is a decorative fountain.

23. The remote-controlled decoration as claimed in claim 1, wherein the decorative main body is a waterglobe.

24. The remote-controlled decoration as claimed in claim 1, wherein the decorative main body is a stepping stone.

25. The remote-controlled decoration as claimed in claim 1, wherein the decorative main body is an indoor/outdoor seasonal decoration.
